(19) United States
(12) Patent Application Publication
(10) Pub. No.: US 2022/0389549 A1
(43) Pub. Date: Dec. 8, 2022

(54) IRON-BASED HIGH CORROSION AND WEAR RESISTANCE ALLOYS

(71) Applicant: OERLIKON METCO (US) INC., Westbury, NY (US)

(72) Inventor: Cameron Jacob EIBL, Encinitas, CA (US)

(73) Assignee: OERLIKON METCO (US) INC., Westbury, NY (US)

(21) Appl. No.: 17/775,770

(22) PCT Filed: Dec. 1, 2020
(86) PCT No.: PCT/US2020/062714

§ 371 Date: May 10, 2022

Related U.S. Application Data
(60) Provisional application No. 62/949,761, filed on Dec. 18, 2019.

(51) Int. Cl. C22C 38/32; C22C 38/22; C23C 4/067; C23C 4/12; F16D 65/12

(52) U.S. Cl. CPC C22C 38/32; C22C 38/22; C23C 4/067; C23C 4/12; F16D 65/127; F16D 2250/0046

(57) ABSTRACT

Example embodiments relate to alloys having high corrosion resistance and high wear resistance. In particular, example embodiments relate to an iron-based alloy including 20 wt % to 50 wt % Cr; 0 wt % to 15 wt % Mo; 0 wt % to 15 wt % W; 3 wt % to 6 wt % B; and a balance of iron and impurities. In example embodiments, the pitting resistance equivalent number (PREN) is greater than 30 at 1300 K under substantially equilibrium solidification conditions. In example embodiments, the mole fraction of a hard phase of the alloy is between 45% and 80% at 1300K under substantially equilibrium solidification conditions. The liquidus of the alloy may be less than 2000K under substantially equilibrium solidification conditions.

### CROSS-REFERENCE TO RELATED APPLICATION

1. This International Application claims the benefit of U.S. Provisional Application No. 62/949,761 filed Dec. 18, 2019, the disclosure of which is expressly incorporated by reference herein in its entirety.

### BACKGROUND

2. Field of the Disclosure

This technology generally relates to alloys having high corrosion resistance and high wear resistance. In particular, example embodiments relate to iron-based alloys used in automotive disk brakes.

3. Background Information

Gray cast iron is the current standard material for brake discs in many transportation options such as cars and trucks. It is a good option because of its low cost, easy manufacturability via casting, and acceptable mechanical properties. However, gray cast iron has some problematic attributes including low wear resistance resulting in high material losses during operation and low corrosion resistance resulting in corrosion during normal operation. Combined with regulatory pressure, there is increasing demand for brake disc material solutions that maintain the attractive attributes of cast iron but reduce the corrosion and wear issues that the material faces in the field. Alternative technologies such as composite brake discs are frequently unattractive for mass production due to high costs. In general, two main factors among others are driving this market trend. The first factor is the increasing pressure from regulators to reduce fine particulate emissions originating from the wear of brake discs, and the second factor is the decreasing use of friction braking in vehicles capable of regenerative braking resulting in the corrosion of cast iron brakes. The visible corrosion (rust) is an issue of aesthetics, but can also reduce braking effectiveness.

Furthermore, in many coating applications, there is strong regulatory and safety pressure to reduce or eliminate the use of nickel and/or cobalt. Both these materials are commonly used as a metallic phase in thermal spray and other coatings.

### SUMMARY

In example embodiments, alloys and coatings provide improved brake disc performance by increasing wear and corrosion resistance of the disc. This may result in reduced particulate emissions, improved disc aesthetics, and/or improved braking performance compared to standard material such as gray cast iron. Further, because alloys of the example embodiments are iron-based, they can be provided and used at a competitive cost compared to more expensive metals and/or composite materials.

Alloys according to example embodiments are iron-based, and may limit the amount of incorporated cobalt and nickel, thus improving their attractiveness for numerous wear and corrosion applications.

Example embodiments include iron-based alloys that have high corrosion and wear resistance via in-situ formation of a corrosion-resistant matrix and high volume/mole fraction of hard phases. In example embodiments, borides make up the hard phase, which is beneficial from a design standpoint, as boron has a substantially low solid solution solubility with iron and iron alloys that drive the precipitation of boride phases, even under the rapid cooling rates inherent in thermal spray and/or powder atomization. With the formation of these beneficial phases, deleterious phases, including intermetallic phases such as sigma or laves phases, which may reduce the toughness and ductility of the alloy, may be reduced or eliminated. In example embodiments, alloys may reduce the fraction of intermetallic phases due to the elemental balance in the alloy, and the reduction of the deleterious intermetallic phases may also be thermodynamically driven by the free energy of formation of the various phases during solidification. In example embodiments, the manufacturability of an alloy via atomization may be performed by controlling the liquidus temperature of the alloy.

In example embodiments, an iron-based alloy includes 20 wt % to 50 wt % Cr, 0 wt % to 15 wt % W, 0 wt % to 15 wt % Mo, and 3 wt % to 6 wt % B. In example embodiments, the Pitting Resistance Equivalent Number (PREN), which is calculated as Cr+3.3*(Mo+0.5*W)+16*N is greater than 30 at 1300 K under substantially equilibrium solidification conditions. In example embodiments, a mole fraction of a hard phase of the alloy is between 40% and 80% at 1300K under substantially equilibrium solidification conditions. In example embodiments, if the mole fraction of the hard phase of the alloy is greater than 80%, the excessive fraction of intermetallic phases and/or borides may lead to embrittlement and poor mechanical properties, along with reduced toughness and ductility. In example embodiments, a mole fraction the hard phase of the alloy that is less than 45% leads to reduced wear performance.

In example embodiments, a liquidus of the alloy is less than 2000K under substantially equilibrium solidification conditions. In example embodiments, if the liquidus is greater than 2000K, the manufacturability of the material via atomization is reduced, which would render the process expensive and reduce production yield. In example embodiments, if the concentration of Cr is greater than 50 wt %, laves phases may be formed, resulting in low PREN and low corrosion resistance. In example embodiments, if the concentration of W or Mo is greater than 15 wt %, laves phases may be formed, resulting in high cost and low pitting corrosion resistance. In example embodiments, if the concentration of B is greater than 6 wt %, excessive hard phases may be formed, resulting in low wear performance.

### BRIEF DESCRIPTION OF THE DRAWINGS

The present disclosure is further described in the detailed description which follows, in reference to the noted plurality of drawings, by way of non-limiting examples of preferred embodiments of the present disclosure, in which like characters represent like elements throughout the several views of the drawings.

FIG. 1 is a diagram illustrating the thermodynamic solidification of an alloy (X4), according an example embodiment.

FIG. 2 is a diagram illustrating the thermodynamic solidification of an alloy (X5), according an example embodiment.

FIG. 3 is an illustration of the microstructure of a splat quenched arc melted ingot of X4, according an example embodiment.

FIG. 4 is an illustration of the microstructure of a splat quenched arc melted ingot of X5, according an example embodiment.

FIG. 5 is a diagram illustrating the thermodynamic solidification of an alloy (X9), according an example embodiment

### DETAILED DESCRIPTION

Through one or more of its various aspects, embodiments and/or specific features or sub-components of the present disclosure are intended to bring out one or more of the advantages as specifically described above and noted below.

### Thermodynamics

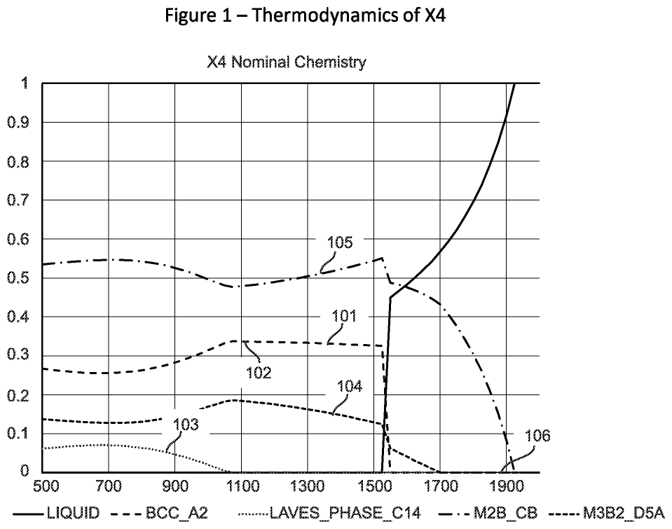

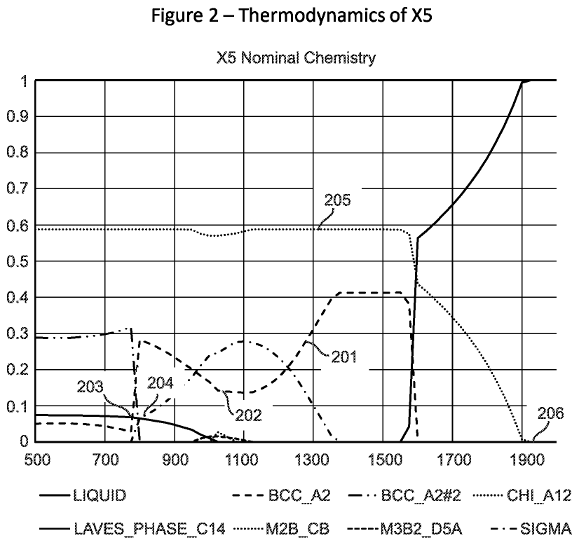

In example embodiments of this disclosure, an alloy can be described fully by equilibrium or near-equilibrium thermodynamic parameters, as illustrated in FIGS. 1 and 2. One way of predicting the corrosion performance of ferrous alloys is with the PREN, calculated according to Equation (1) below:

PREN=Cr+3.3*(Mo+0.5*W)+16*N (1),

where the elemental values are in weight percent.

In single phase materials, such as most ferritic stainless steels, the PREN is applied to the bulk alloy composition. However, because alloys in this disclosure may include multiple phases, the PREN number is calculated based on the equilibrium thermodynamic condition of the matrix phase, while not taking into account the composition of other phases that may form, such as, e.g., borides. The matrix phase is defined as the face-centered cubic (FCC) or body-centered cubic (BCC) iron-rich metallic phase. Accordingly, the matrix PREN value may be used to accurately predict the relative corrosion performance of multi-phase materials. In example embodiments of this disclosure the matrix phase is BCC ferrite.

FIG. 1 is a diagram illustrating thermodynamic solidification of an alloy (X4), according an example embodiment. In FIG. 1, the X-axis represents temperature and the Y-axis represents mole fraction. As illustrated in FIG. 1, the matrix PREN for alloy X4 is calculated as 32.5; based on a calculated Cr content of 21.2 wt %, Mo content of 1.9%, and W content of 3.0 wt %; at 1300K as designated by the label 101, and as 20.0 at 1000K; based on Cr content of 16.9 wt %, Mo content of 0.46 wt %, and W content of 0.98 wt %; as designated by the label 102 based on the chemistry of the BCC phase, which is the only matrix phase present under equilibrium solidification conditions.

FIG. 2 is a diagram illustrating thermodynamic solidification of an alloy (X5), according an example embodiment. In FIG. 2, the X-axis represents temperature and the Y-axis represents mole fraction. In FIG. 2, the matrix PREN for Alloy X5 is calculated as 42.7 at 1300K; based on a calculated Cr content of 31.2 wt %, Mo content of 2.0 wt %, and W content of 3.0 wt %, as designated by the label 201, and as 25.0 at 1000K, as designated by the label 202 based on the chemistry of the BCC phase comprising a calculated Cr content of 21.9 wt %, Mo content of 0.56 wt %, W content of 0.78 wt %.

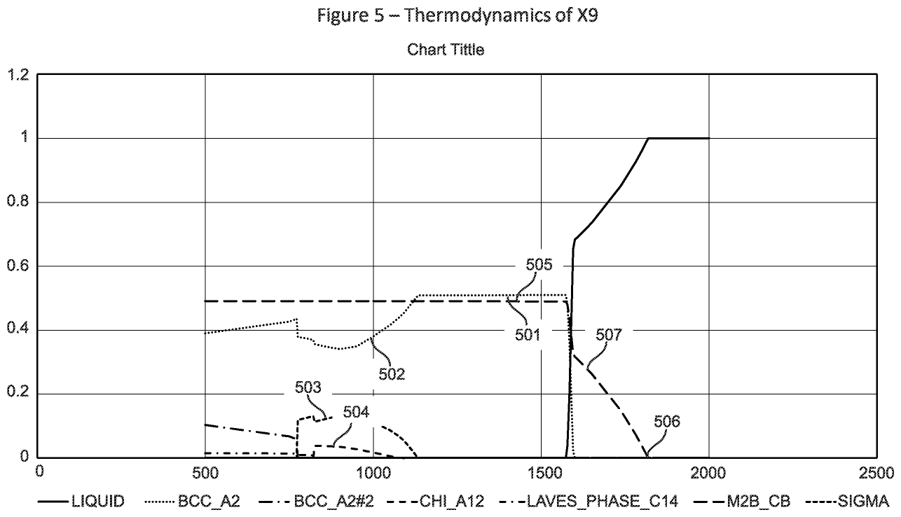

FIG. 5 is a diagram illustrating thermodynamic solidification of an alloy (X9), according an example embodiment. In FIG. 5, the X-axis represents temperature and the Y-axis represents mole fraction. In FIG. 5, the matrix PREN for Alloy X9 is calculated as 35.7 at 1300K; based on a calculated Cr content of 30.1 wt % and a W content of 3.4 wt % as designated by the label 501, and as 27.0 at 1000K, as designated by the label 502 based on the chemistry of the BCC phase calculated as a Cr content of 24.6 wt % and a W content of 1.5 wt %.

Table 1 below provides a list of alloys produced via arc melting and their nominal chemistry in weight percent.

TABLE 1
Nominal Concentrations of Alloys Manufactured via Arc Melting

| | B | Cr | Fe | Mo | W |
|---|---|---|---|---|---|
| P130-X1 | 4.5 | 40 | Bal | 2 | 0 |
| P130-X2 | 5.1 | 34 | Bal | 10 | 2 |
| P130-X3 | 4.5 | 38 | Bal | 4 | 2 |
| P130-X4 | 5.3 | 32 | Bal | 10 | 4 |
| P130-X5 | 4.5 | 42 | Bal | 4 | 2 |
| P130-X6 | 4.5 | 44 | Bal | 4 | 2 |
| P130-X7 | 4.4 | 41 | Bal | 0 | 2 |
| P130-X9 | 3.7 | 40 | Bal | 0 | 2 |

In example embodiments of this disclosure the matrix PREN at 1300K is greater than 30 (0.30 on the Y axis). In other example embodiments of this disclosure the matrix PREN at 1300K is greater than 32 (0.32 on the Y axis). In other example embodiments of this disclosure the matrix PREN at 1300K is greater than 34 (0.34 on the Y axis). In further example embodiments of this disclosure the matrix PREN at 1300K is greater than 38 (0.38 on the Y axis). In still other example embodiments of this disclosure the matrix PREN at 1300K is greater than 40 (0.40 on the Y axis).

Moreover, in example embodiments of this disclosure the matrix PREN at 1000K is greater than 15 (0.15 on the Y axis). In further example embodiments of this disclosure the matrix PREN at 1000K is greater than 17 (0.17 on the Y axis). In still further example embodiments of this disclosure the matrix PREN at 1000K is greater than 19 (0.19 on the Y axis). In example embodiments of this disclosure the matrix PREN at 1000K is greater than 20 (0.20 on the Y axis).

Another way of predicting the corrosion performance of a ferrous alloy is by measuring the chromium content of the alloy. In example embodiments, the chromium content is calculated for the matrix phase under equilibrium solidification conditions. Table 2 below also lists manufactured alloys and their calculated matrix chromium contents under equilibrium solidification conditions.

In example embodiments, at 1300K the matrix comprises, in weight percent, greater than 16% chromium. In other example embodiments, at 1300K the matrix comprises, in weight percent, greater than 18% chromium. In further example embodiments, at 1300K the matrix comprises, in weight percent, greater than 20% chromium. In still further example embodiments, at 1300K the matrix comprises, in weight percent, greater than 22% chromium. In still further example embodiments, at 1300K the matrix comprises, in weight percent, greater than 24% chromium. In still further example embodiments, at 1300K the matrix comprises, in weight percent, greater than 26% chromium. In still further example embodiments, at 1300K the matrix comprises, in weight percent, greater than 28% chromium.

Chromium is advantageous for corrosion resistance in high chloride environments; however the presence of molybdenum and tungsten also improves the pitting resistance of ferrous alloys in high chloride environments where Cr is also present. Table 2 below also lists manufactured alloys and their calculated matrix molybdenum plus tungsten content under equilibrium solidification conditions.

In example embodiments at 1300K the matrix comprises, in weight percent, greater than 0.5% of molybdenum and tungsten combined. In example embodiments at 1300K the matrix comprises, in weight percent, greater than 1% of molybdenum and tungsten combined. In example embodiments at 1300K the matrix comprises, in weight percent, greater than 2% of molybdenum and tungsten combined. In other example embodiments at 1300K the matrix comprises, in weight percent, greater than 4% molybdenum and tungsten combined.

The formation of intermetallic phases in high Cr, Mo, and/or W stainless steels is a problem with high fractions of intermetallic phases correlated with reduced toughness and/or ductility. As this material is intended to have reduced to no cracking after deposition via thermal spray or other process, it is advantageous to reduce the presence of any embrittling phases. In example embodiments, the intermetallic phase mole fraction is defined as the sum under equilibrium solidification conditions of all chi, sigma, and laves phases. In some applications such as brake discs, the surface temperature may reach 800K during extreme braking events, and as a result it is advantageous that intermetallic phases do not precipitate during service.

In the alloy X4 illustrated in FIG. 1, the only intermetallic phase present at 800K is a laves phase designated by the label 103, so the intermetallic mole phase fraction at 800K is calculated as 6.4%. In the alloy X5 illustrated in FIG. 2, there is both a laves phase designated by the label 203 and a sigma phase designated by the label 204 at 800K, so the total calculated mole fraction is 13.0%. In the alloy X9 illustrated in FIG. 5 there is both a laves phase designated by the label 503 and a CHI phase designated by the label 504 at 800K so the total calculated mole fraction is 13.5%.

In example embodiments, at 800K the alloy comprises, in mole percent, less than 20% intermetallic phases. In other example embodiments, at 800K the alloy comprises, in mole percent, less than 15% intermetallic phases. In further example embodiments, at 800K the alloy comprises, in mole percent, less than 10% intermetallic phases. In still further example embodiments, at 800K the alloy comprises, in mole percent, less than 8% intermetallic phases.

The formation of hard phases such as borides, carbides, borocarbides, oxides, and nitrides can improve the wear resistance of an alloy. There are practical limits to the fraction of hard phases where excessively high values may lead to the alloy cracking after deposition or in service, especially when exposed to cyclical and rapid changes in temperature. Hard phases in this disclosure can be calculated as the sum of all borides, carbides, borocarbides, oxides, and/or nitrides under equilibrium solidification conditions.

In the alloy X4 illustrated in FIG. 1, there are two hard phases present at 1300K: an M3B2 phase designated by the label 104 and an M2B phase designated by the label 105; the sum of these hard phases is 66.7 mol %. In the alloy X5 illustrated in FIG. 2, there is only one hard phase present, M2B designated by the label 205, so the mole fraction of hard phases at 1300K is 58.8%. In the alloy X9 illustrated in FIG. 5, there is only one hard phase present, M2B designated by the label 505, so the mole fraction of hard phases at 1300K is 49%.

In example embodiments, the mole fraction of hard phases under equilibrium or near equilibrium solidification conditions is between 45% and 80%. In other example embodiments of this disclosure, the mole fraction of hard phases is between 50% and 75%. In further example embodiments of this disclosure, the mole fraction of hard phases is between 50% and 60%. In still further example embodiments of this disclosure, the mole fraction of hard phases is between 55% and 70%. In example embodiments, the mole fraction of hard phases under equilibrium or near equilibrium solidification conditions is between 35% and 65%. In other example embodiments of this disclosure, the mole fraction of hard phases is between 40% and 60%. In further example embodiments of this disclosure, the mole fraction of hard phases is between 45% and 55%.

The formation of high temperature phases during melting and atomization may reduce the manufacturability of an alloy by limiting fluidity. Limited fluidity may require special equipment to melt, may reduce the yield of atomization, and/or render production impossible on an industrial scale. To ensure higher fluidity, the liquidus temperature under equilibrium solidification conditions is controlled, as lower liquidus temperature correlates to improved fluidity during atomization. In example embodiments, the fluidity and the liquidus temperature may be inversely correlated.

Liquidus temperature is defined thermodynamically as the lowest temperature where the alloy is 100% liquid. In alloys X4 and X5, the liquidus temperature is 1925K as designated by the labels 106 and 206. In alloy X9, the liquidus temperature is 1819K.

In example embodiments, the liquidus temperature of the alloy is less than 2000K. In other example embodiments, the liquidus temperature of the alloy is less than 1975K. In further example embodiments, the liquidus temperature of the alloy is less than 1950K. In still further example embodiments, the liquidus temperature of the alloy is less than 1925K. In still further example embodiments, the liquidus temperature of the alloy is less than 1900K. In still further example embodiments, the liquidus temperature of the alloy is less than 1875K. In still further example embodiments, the liquidus temperature of the alloy is less than 1850K.

The matrix phase structure can dictate the suitability of the material for brake disc and other applications. Alloys in this disclosure may in some embodiments have a ferritic matrix designated as BCC_A2 in FIGS. 1, 2, and 5. In some embodiments the only matrix phase is BCC_A2 with no iron FCC iron phase. In some embodiments the fraction of FCC iron matrix phase at any temperature is less than 5 mol %. In some embodiments the fraction of FCC iron matrix phase at any temperature is less than 10 mol %. In some embodiments the fraction of FCC iron matrix phase at any temperature is less than 20 mol %. In some embodiments the fraction of FCC iron matrix phase at any temperature is less than 25 mol %.

In some embodiments it is preferable that the hardphase is entirely or primarily a chromium boride. This is advantageous as the chromium content contributes to good corrosion performance. Chromium borides also form at lower temperatures than many other hard phases such as MC carbides and borides of Molybdenum and Tungsten. The mole fraction of chromium boride is defined as the fraction of M2B at 1300K where M2B comprises more than 90% Fe+Cr+B.

In Alloy X9 shown in FIG. 5 the chromium boride fraction is 49 mol %. In some embodiments of this disclosure the mole fraction of chromium boride is between 40 and 65 mol %. In some embodiments of this disclosure the mole fraction of chromium boride is between 45 and 55 mol %. In some embodiments of this disclosure the mole fraction of chromium boride is between 45 and 70 mol %. In some embodiments of this disclosure the mole fraction of chromium boride is between 55 and 70 mol %.

In some embodiments it is important that the hardphases form primarily as hyper eutectic phases. This ensures that the hardphases are sufficiently coarse after being atomized or otherwise manufactured into a powder. Hard phases that are too fine may not provide the desired abrasion and/or wear properties needed for a given application. The hypereutectic hard phase fraction is measured as the sum of all hard phases at the lowest temperature where the matrix has not yet solidified. In FIG. 5, Alloy X9 this occurs at 1600K. Thus the hypereutectic hardphase fraction in X9 is 31.7 mol % as in label 507 of FIG. 5.

In some embodiments, hypereutectic hardphase fraction is greater than 25%. In some embodiments, hypereutectic hardphase fraction is greater than 28%. In some embodiments, hypereutectic hardphase fraction is greater than 30%.

### Microstructure

In example embodiments, alloys may also be described by their microstructural features. The formation of hard phases such as borides, carbides, borocarbides, oxides, and nitrides can improve the wear resistance of an alloy. There are practical limits to the fraction of hard phases where excessively high values may lead to the alloy cracking after deposition or in service, especially when exposed to cyclical and rapid changes in temperature. Hard phases in this disclosure can be calculated as the sum of all borides, carbides, borocarbides, oxides, and nitrides as measured using quantitative metallography techniques on arc melted samples of the alloys.

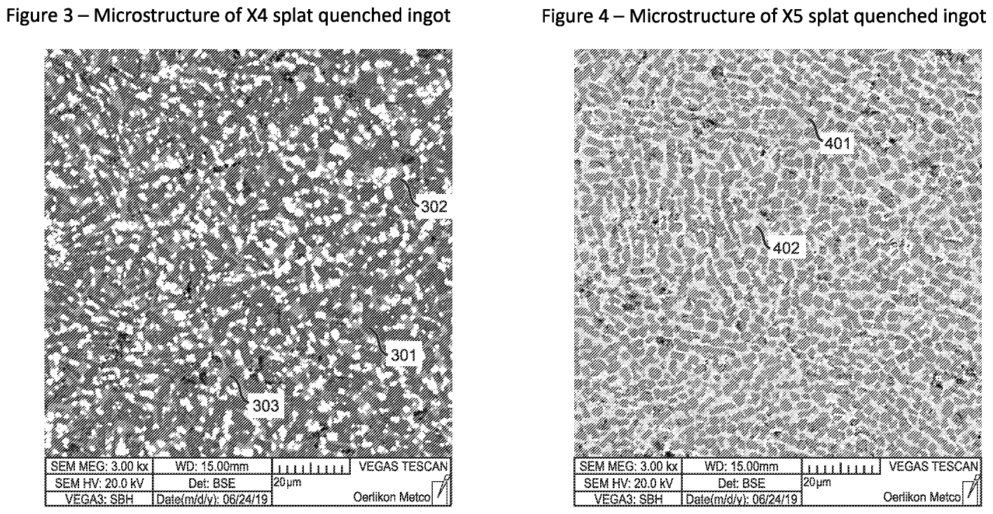

In the microstructure of alloy X4 illustrated in FIG. 3, the volume fraction of the hard phase is measured as the sum of the iron chromium borides, designated by the label 301, and iron chromium molybdenum tungsten borides, designated by the label 302, at 67%. In the microstructure of alloy X5 illustrated in FIG. 4, the volume fraction of the hard phase is measured as the sum of the iron chromium borides, designated by the label 401, at 57%.

The PREN of the matrix phase is a strong predictor of corrosion performance of the alloy. As discussed above with respect to Equation (1), PREN is calculated as [Cr+3.3*(Mo+0.5*W)+16*N], where elemental values are in weight percent. Elemental weight percent is measured using energy-dispersive X-ray spectroscopy (EDS) in a scanning electron microscope (SEM)

In the microstructure of alloy X4 illustrated in FIG. 3, the PREN is calculated from the matrix phase, designated by the label 303, measured via EDS as being equal to 38.3. In the microstructure of alloy X5 illustrated in FIG. 4, the PREN of the matrix phase, designated by the label 402, is measured as being equal to 48.3. Measured matrix PREN values for all arc melted alloys manufactured are listed in Table 2.

TABLE 2
Thermodynamic and empirical results of arc melted alloys

| | Matrix | 1300 K | Matrix | Matrix | Matrix | | Intermetallic | | Measured |
|---|---|---|---|---|---|---|---|---|---|
| | PREN | Hard Phase | Cr at | Mo + W at | PREN at | Liquidus | mol % at | Measured | Cr in |
| | 1300 K | mol % | 1300 k | 1300 K | 1000 K | in K | 800 K | PREN | BCC |
| P130-X1 | 31.5 | 57.7 | 27.8% | 1.1% | 25.39 | 1900 | 2.3% | 27.0 | 18.7% |
| P130-X2 | 34.8 | 64.3 | 24.0% | 4.3% | 24.66 | 1925 | 7.8% | 33.9 | 18.1% |
| P130-X3 | 39.0 | 58.8 | 25.4% | 6.1% | 25.01 | 1900 | 6.5% | 35.9 | 18.1% |
| P130-X4 | 32.5 | 66.7 | 21.2% | 5.0% | 20.02 | 1925 | 6.4% | 38.3 | 23.7% |
| P130-X5 | 42.7 | 58.8 | 31.2% | 5.0% | 25.01 | 1925 | 13.0% | 48.3 | 18.9% |
| P130-X6 | 44.6 | 58.7 | 34.4% | 4.3% | 25.01 | 1925 | 18.7% | 46.5 | 25.8% |
| P130-X7 | 35.1 | 57 | 28.8% | 3.9% | 27.00 | 1900 | 6.3% | 43.0 | 20.1% |
| P130-X9 | 35.7 | 49.1 | 30.1 | 3.4% | 27.0 | 1819 | 13.5% | 42 | 23% |

In some applications, the alloys described in this disclosure may be deposited as a coating intended to provide corrosion resistance. Where corrosive media are present, such as high chloride content water, excessive coating porosity may allow corrosive media to penetrate to the substrate. If this penetration occurs, corrosion of the substrate may lead to surface discoloration, reduced overlay performance, and/or disbanding of the coating from the substrate. As a result, it may be advantageous to control the percentage of porosity in a coating deposited by thermal spraying, or by other deposition methods.

Table 3 below summarizes alloys of this disclosure that have been sprayed via HVOF at 3 parameters and their resulting porosity as measured via ASTM E2109-01.

In example embodiments, the coating formed from alloys described may have a porosity that is less than 3%. In other example embodiments of this disclosure, the coating formed from alloys described may have a porosity that is less than 2%. In further example embodiments of this disclosure, the coating formed from alloys described may have a porosity that is less than 1.5%. In still further example embodiments of this disclosure, the coating formed from alloys described may have a porosity that is less than 1%.

A predictor of coating wear performance may be the hardness measured via the Vickers testing method at 0.3 kgf (HV0.3). Excessive hardness on the other hand can be indicative of low toughness and/or ductility, potentially resulting in cracking or spalling in service. Hardness is generally inversely correlated to toughness or ductility. Table 3 below summarizes the HV0.3 values for three HVOF sprayed alloys of this disclosure.

In example embodiments, the Vickers hardness HV0.3 is between 500 and 1050. In example embodiments, HV0.3 is between 600 and 950.

TABLE 3
Results of HVOF sprayed powders

| | Porosity % | Psi Bond | | | |
|---|---|---|---|---|---|
| | (ASTM | Strength | Hardness | DE | Param- |
| Alloy | E2109-01) | (C633-13) | HV0.3 | % | eter |
| P130-X5 | <1 | 9445 ± 1844 | 783 ± 84 | 64.76 | A |
| | 1.4 ± 0.2 | 11820 ± 143 | 787 ± 92 | 65.23 | B |
| | 1.6 ± 0.5 | 6867 ± 557 | 871 ± 82 | 74.56 | C |
| P130-X7 | 1.4 ± 0.4 | 10926 ± 450 | 790 ± 68 | 67.63 | C |
| | 1.5 ± 0.5 | 10308 ± 2998 | 754 ± 108 | 67.46 | B |
| | <1 | 12076 ± 365 | 769 ± 98 | 58.55 | A |
| P130-X4 | 2.2 ± 0.3 | 8861 ± 2453 | 919 ± 50 | 78.01 | C |
| | 1.2 ± 0.2 | 9747 ± 777 | | 76.36 | B |
| | <1 | 9695 ± 383 | 904 ± 69 | 71.42 | A |

### Chemistry

In example embodiments of this disclosure, alloys may be described by their bulk chemistry. In other example embodiments, the powders comprise in weight percent: 20% to 50% Chromium, 0% to 15% Molybdenum, 0% to 15% Tungsten, 3% to 6% Boron. In further example embodiments the powders comprise in weight percent: 25% to 50% Chromium, 0% to 15% Molybdenum, 0% to 15% Tungsten, 3% to 6% Boron. In still further example embodiments the powders comprise in weight percent: 30% to 45% Chromium, 0% to 15% Molybdenum, 0% to 15% Tungsten, 3% to 6% Boron. In still further example embodiments the powders comprise in weight percent: 20% to 50% Chromium, 0% to 15% Molybdenum, 0% to 15% Tungsten, 3.3% to 5.5% Boron. In other example embodiments the powders comprise in weight percent: 20% to 50% Chromium, 0% to 15% Molybdenum, 0% to 15% Tungsten, 3.3% to 5.5% Boron. It is understood that in the above embodiments, the balance of alloy elements includes iron and impurities.

In example embodiments the powders comprise in weight percent: 28% to 36% Chromium, 8% to 12% Molybdenum, 2% to 6% Tungsten, 4.8% to 5.6% Boron, balance iron and impurities. In other example embodiments the powders comprise in weight percent: 25% to 39% Chromium, 7% to 13% Molybdenum, 2% to 6% Tungsten, 4.6% to 5.8% Boron. It is understood that in the above embodiments, the balance of alloy elements includes iron and impurities.

In example embodiments the powders comprise in weight percent: 38% to 46% Chromium, 3% to 6% Molybdenum, 0% to 4% Tungsten, 4.0% to 4.8% Boron, balance iron and impurities. In other example embodiments the powders comprise in weight percent: 36% to 48% Chromium, 2% to 8% Molybdenum, 0% to 6% Tungsten, 3.8% to 5.0% Boron. It is understood that in the above embodiments, the balance of alloy elements includes iron and impurities.

In example embodiments, the powders comprise in weight percent: 36% to 48% Chromium 0% to 4% Tungsten, 3.8% to 4.8% Boron, the balance including iron and impurities.

In example embodiments, the powders comprise in weight percent: 35% to 45% Chromium 0% to 4% Tungsten, 3.4% to 4.2% Boron, the balance including iron and impurities.

In example embodiments, the powders comprise in weight percent: 35% to 45% Chromium 0% to 4% Molybdenum plus Tungsten, 3.4% to 4.2% Boron, the balance including iron and impurities.

In example embodiments, the powders comprise in weight percent: 35% to 45% Chromium 0% to 8% Molybdenum plus Tungsten, 3.4% to 4.2% Boron, the balance including iron and impurities.

In example embodiments, the powders comprise in weight percent: 35% to 45% Chromium 0.5% to 4% Molybdenum plus Tungsten, 3.4% to 4.2% Boron, the balance including iron and impurities.

In example embodiments, the powders comprise in weight percent: 35% to 45%, 3.4% to 4.2% Boron,

In example embodiments, the powders comprise in weight percent less than 1% carbon. In other example embodiments, the powders comprise in weight percent less than 0.5% carbon. In further example embodiments, the powders comprise in weight percent less than 0.25% carbon. In still further example embodiments, the powders comprise in weight percent less than 0.1% carbon.

Because of regulatory, environmental, and safety concerns, it may be desirable to limit nickel and/or copper in all wear surfaces because excessive nickel concentration leads to reduced ferrite stability and an increased risk on the environment. Example embodiments of this disclosure specifically limit the nickel content of the feedstock powder.

In example embodiments, the powder and coating produced comprise less than 5 wt % nickel. In other example embodiments, the powder and coating produced comprise less than 2 wt % nickel. In further example embodiments, the powder and coating produced comprise less than 1 wt % nickel. In still further example embodiments, the powder and coating produced comprise less than 0.5 wt % nickel. In still further example embodiments, the powder and coating produced comprise less than 0.2 wt % nickel. In other example embodiments, the powder and coating produced comprise less than 0.15 wt % nickel. In still further example embodiments, the powder and coating produced comprise less than 0.1 wt % nickel.

In example embodiments, the powder and coating produced comprise less than 5 wt % copper. In other example embodiments, the powder and coating produced comprise less than 2 wt % copper. In further example embodiments, the powder and coating produced comprise less than 1 wt % copper. In still further example embodiments, the powder and coating produced comprise less than 0.5 wt % copper. In still further example embodiments, the powder and coating produced comprise less than 0.2 wt % copper. In other example embodiments, the powder and coating produced comprise less than 0.15 wt % copper. In still further example embodiments, the powder and coating produced comprise less than 0.1 wt % copper.

### Applications

In example embodiments, alloys are manufactured into powders. In example embodiments, the alloys are manufactured into powders by gas atomization. Table 4 below provides measured gas atomized powder chemistries of alloys according to embodiments of this disclosure. In example embodiments of this disclosure, alloys described are manufactured into powders by water atomization.

TABLE 4
Measured chemistry of alloys manufactured
into powder for thermal spray

| Alloy | Fe | Cr | Mo | W | B | C |
|---|---|---|---|---|---|---|
| P130-X4 | Bal | 31.9 | 10 | 4.1 | 5.2 | 0.08 |
| P130-X5 | Bal | 41.4 | 4.5 | 1.9 | 4.4 | 0.05 |
| P130-X7 | Bal | 40.8 | N/A | 1.9 | 4.3 | 0.06 |
| P130-X9 | Bal | 40.1 | 0 | 2.1 | 3.7 | 0.07 |

In example embodiments, the alloy may be deposited via high velocity oxygen fuel (HVOF) spraying. In other example embodiments of this disclosure, the alloy may be deposited via gas fuel HVOF spraying. In further example embodiments of this disclosure, the alloy may be deposited via liquid fuel HVOF spraying. In still further example embodiments of this disclosure, the alloy may be deposited via high velocity air fuel (HVAF) spraying. In still further example embodiments of this disclosure, the alloy may be deposited via plasma spraying. In other example embodiments of this disclosure, the alloy may be deposited via combustion spraying. In further example embodiments of this disclosure, the alloy may be deposited via high velocity arc wire spraying. In example embodiments of this disclosure, the alloy may be deposited via twin wire arc spraying (TWAS). Alloys of this disclosure may be sintered to form a wear body. Alloys of this disclosure may be cast to form a wear component.

Alloys of this disclosure may be used on brake discs and brake drums for passenger vehicles. The alloys may be used for medium and heavy duty road vehicles. The alloys may be used for brake discs in transportation generally such as trains, street cars, motorcycles, off highway vehicles, mining trucks.

The illustrations of the embodiments described herein are intended to provide a general understanding of the various embodiments. The illustrations are not intended to serve as a complete description of the entirety of the elements and features of apparatus and systems that utilize the structures or methods described herein. Many other embodiments may be apparent to those of skill in the art upon reviewing the disclosure. Other embodiments may be utilized and derived from the disclosure, such that structural and logical substitutions and changes may be made without departing from the scope of the disclosure. Additionally, the disclosure and the figures are to be regarded as illustrative rather than restrictive.

One or more embodiments of the disclosure may be referred to herein, individually and/or collectively, by the term “invention” merely for convenience and without intending to voluntarily limit the scope of this application to any particular invention or inventive concept. Moreover, although specific embodiments have been illustrated and described herein, it should be appreciated that any subsequent arrangement designed to achieve the same or similar purpose may be substituted for the specific embodiments shown. This disclosure is intended to cover any and all subsequent adaptations or variations of various embodiments. Combinations of the above embodiments, and other embodiments not specifically described herein, will be apparent to those of skill in the art upon reviewing the description.

1. An iron-based alloy comprising:
20 wt % to 50 wt % Cr;
3 wt % to 6 wt % B;
Mo;
W; and
a balance of iron and impurities;
wherein a pitting resistance equivalent number (PREN) of a matrix phase as defined in Equation (1) is greater than 30 at 1300 K under substantially equilibrium solidification conditions:
PREN=Cr×3.3*(Mo+.05*W)+16*N (1);
wherein a mole fraction of a hard phase of the alloy is between 40% and 80% at 1300K under substantially equilibrium solidification conditions; and
wherein a liquidus of the alloy is less than 2000K under substantially equilibrium solidification conditions.

2. The alloy of claim 1 that comprises between 0.5 and 20 wt % Mo+W

3. The alloy of claim 1, where PREN of the matrix phase is greater than 20 at 1000K under substantially equilibrium solidification conditions.

4. The alloy of claim 1 wherein a concentration of Cr at 1300K in the matrix phase is greater than 15 wt % and less than 35 wt% Cr, and a sum of concentrations of molybdenum and tungsten at 1300K is greater than 2 wt % and less than 35 wt % under substantially equilibrium solidification conditions.

5. The alloy of claim 1, where a mole fraction of intermetallic phases at 800 K is less than 20% under substantially equilibrium solidification conditions.

6. A method of forming the alloy of claim 1, the method comprising atomizing the alloy to form a powder.

7. A method of forming a wear and corrosion-resistant coating, the method comprising depositing the alloy of claim 1 onto a substrate.

8. The alloy of claim 1 where an arc melted microstructure of the alloy comprises between 45% and 80% of the hard phase by volume.

9. The alloy of claim 1, wherein the PREN of an arc melted ingot microstructure is greater than 25.

10. The alloy of claim 1, wherein the alloy is deposited via HVOF and has a porosity of less than 3%.

11. A method of forming a wear and corrosion-resistant coating, the method comprising depositing the alloy of claim 1 onto a brake disc wear surface.

12. The alloy of claim 1, wherein the hard phase comprises at least one of borides, carbides, borocarbides, oxides, and nitrides.

12. The alloy of claim 1, wherein a concentration of Mo is up to 15 wt %.

13. The alloy of claim 1, wherein a concentration of W is up to 15 wt %.

14. The alloy of claim 1, wherein a concentration of Mo is up to 15 wt %.
